(19) United States
(12) Patent Application Publication
(10) Pub. No.: US 2009/0242697 A1
(43) Pub. Date: Oct. 1, 2009

(54) VEHICLE WITH BUOYANCY BODIES

(75) Inventors: Dieter Schmidt, Fuldabruck (DE); Klaus-Peter Gerlach, Guxhagen (DE)

Correspondence Address: GRIFFIN & SZIPL, PC, SUITE PH-1, 2300 NINTH STREET, SOUTH, ARLINGTON, VA, 22204, US

(73) Assignee: Rheinmetall Landsysteme GmbH, Kiel (DE)

(21) Appl. No.: 12/413,376

(22) Filed: Mar. 27, 2009

Related U.S. Application Data
(63) Continuation-in-part of application No. PCT/EP2007/007938, filed on Sep. 12, 2007.

(30) Foreign Application Priority Data
Sep. 28, 2006 (DE) 10 2006 046355.2

(51) Int. Cl. B64C 25/56; B60F 3/00

(52) U.S. Cl. 244/106; 440/12.5

(57) ABSTRACT

According to the invention, inflatable buoyancy bodies are kept in storage housings on the outside of a vehicle. During normal use, buoyancy bodies are folded up and stored under covers. Only when the vehicle is on water do the covers open and buoyancy bodies fill with air. An on-board compressed air system supplies air for filling buoyancy bodies so that air, which is not required by a braking installation or the like of the vehicle, is used to fill the buoyancy bodies. The additional use of outside air enables more air to be supplied to the buoyancy bodies at a low pressure than the sole use of the on-board compressed air system. In order to empty the buoyancy bodies, a vacuum is generated in connection lines. When stop cocks are open, air is sucked out of the buoyancy bodies, which then fold up and the covers are closed and locked.

This is a Continuation-in-Part Application of the United States of International Patent Application No. PCT/EP2007/007938 filed Sep. 12, 2007, which claims priority on German Patent Application No. 10 2006 046 355.2, filed Sep. 28, 2006. The entire disclosures of the above patent applications are hereby incorporated by reference.

### FIELD OF THE INVENTION

The present invention pertains broadly to a vehicle with at least one buoyancy body that is mounted on the vehicle.

### BACKGROUND OF THE INVENTION

From EP 1 572 529 B1, a gas generator for buoyancy bags of watercraft is known and relates to a rescue system for submarines. This apparatus comprises several modules that, for their part, essentially have an inflatable bag and a gas generator. The gas generator produces sufficient gas thereby for the bag to be fully inflated at the greatest depth. The gas generator has a high pressure chamber and a low pressure chamber that are connected by means of a throttle valve.

As published in DE 10 2004 040 A1, a buoyancy aid for watercraft uses a so-called “nosinker.” A nosinker is a buoyancy aid system comprising an inflatable cushion or tube that is mounted on the ceiling, on the floor, and on the walls of the living areas and operation areas of ships, boats, or other vehicles, that at some point in time are intended to float on the water. The nosinker remains in the vehicle and functions to prevent the vehicle itself from sinking.

DE 203 02 095 U1 discloses a rescue system to prevent a vehicle from sinking. At least one airbag is inflatable outwards thereby. In the folded state the rescue system is attached to the vehicle inconspicuously. In the inflated state, an airbag enables sufficient buoyancy to be generated in order to cause the vehicle to float.

A sidewall air cushion is described in DE 42 14 450 A1. The blower used thereby regulates the pressure inside the air cushion while taking into consideration a compression angle or compression angle rate.

DE 201 07 615 U1 concerns an amphibian vehicle for the salvaging of deadwood. For traveling overland, this vehicle has a chassis in the form of wheels or tracks chains arranged on both sides of the hull of the vehicle. Buoyancy devices, in the form of pontoons, are arranged on both sides of the body of the vehicle.

DE 36 01 691 C2 considers a hollow body that is acted upon by a pressure. The cover is partially provided by foam with closed hollow chambers, whose volume can be changed by means of the pressure of fluid media. The foam is also acted upon by an extensive inelastic coating on the outer skin of the hollow body.

DE 29 20 786 B1 describes a buoyant truck with a loading platform embodied in the form of a floating tray. Inflatable elastic lateral buoyancy devices are mounted on both sides of the vehicle, wherein the buoyancy devices, in the inflated state, are essentially orientated horizontally, and in the emptied state are essentially oriented vertically. The elastic lateral buoyancy devices, together with covers and support plate, are arranged on swinging arms that enable the lateral buoyancy devices to be placed in an upper position above the vehicle and in a lateral use position on the two longitudinal sides of the vehicle.

In practice separate gas generators are provided for filling the buoyancy devices or the airbags, respectively, of the above apparatuses. These separate gas generators require additional space on and/or in the vehicle.

The object of the invention is likewise to make a vehicle buoyant that is provided, in particular, with a higher weight (i.e., due to additional armor), but is subject to the problem of restricted construction space in the vehicle (i.e., does not have to have space for a separate gas generator).

### SUMMARY OF THE INVENTION

The object of the invention is achieved by the features of a vehicle (1), in accordance with a first embodiment, that is provided with at least one buoyancy body (5) that is mounted on the vehicle (1), characterized in that the filling of the buoyancy body (5) takes place by supplying air (7) of an onboard air system via at least one line (11). Other advantageous embodiments, in accordance with the present invention, are summarized as follows.

In accordance with a second embodiment of the present invention, the first embodiment is modified so that in addition to the onboard air (7.1), the outside air (7.2) can be sucked in, by which the at least one buoyancy body (5) is acted on. In accordance with a third embodiment of the present invention, the first embodiment and/or the second embodiment is modified so that an ejector nozzle (10) is incorporated in the line (11). In accordance with a fourth embodiment of the invention, the first embodiment, the second embodiment and/or the third embodiment is modified so that buoyancy bodies (5) are mounted bilaterally on the vehicle (1). In accordance with a fifth embodiment of the present invention, the first embodiment, the second embodiment, the third embodiment, and/or the fourth embodiment is modified so that the buoyancy bodies (5) are housed on the vehicle (1) in stowage chambers (3) with covers (4). In accordance with a sixth embodiment of the present invention, the fifth embodiment is further modified so that the buoyancy bodies (5) are fixed to the stowage bodies (3) and the cover flaps (4) preferably are provided with welting profiles.

In accordance with a seventh embodiment of the present invention, the first embodiment, the second embodiment, the third embodiment, the fourth embodiment, the fifth embodiment and/or the sixth embodiment, is modified so that elastic cables are attached in the interior of the buoyancy bodies (5). In accordance with an eighth embodiment of the present invention, the first embodiment, the second embodiment, the third embodiment, the fourth embodiment, the fifth embodiment, the sixth embodiment, and/or the seventh embodiment is further modified so that the buoyancy bodies (5) are preferably made of a rubberized textile. In accordance with a ninth embodiment of the present invention, the first embodiment, the second embodiment, the third embodiment, the fourth embodiment, the fifth embodiment, the sixth embodiment, the seventh embodiment, and the eighth embodiment, is modified so that the buoyancy bodies (5) can be divided into several independent chambers. In accordance with a tenth embodiment of the present invention, the first embodiment, the second embodiment, the third embodiment, the fourth embodiment, the fifth embodiment, the sixth embodiment, the seventh embodiment, the eighth embodiment, and the ninth embodiment, is modified so that the buoyancy bodies (5) fold up by means of removal of the air (7) situated in the buoyancy bodies (5), wherein the buoyancy bodies (5) lie in the right angle between cover flap (4) and the tray (9) of the vehicle (1), and the respective cover flap (4) is then closed and locked via a hydraulic system.

The present invention is based on the concept that the inflatable buoyancy bodies are arranged in an integrated manner on the outside of the vehicle in stowage chambers that are present, for example. In normal use, they are stowed folded up under covers. Only during a floating operation are the covers opened and the buoyancy bodies filled with air. The air for filling the buoyancy bodies is preferably supplied by an on-board compressed air system so that air that is not needed for supporting, for example, a braking installation, or the like, is used for filling the buoyancy bodies.

In accordance with another embodiment of the invention, in addition to the on-board air, more air than the on-board compressed air system makes available is conveyed thereby by means of the ejector principle (e.g. Laval nozzle) into the buoyancy bodies at low pressure by means of additional uptake of outside air.

The pressure in the buoyancy bodies, of the present invention, is measured with sensors, and shut-off valves are activated accordingly. To empty the buoyancy bodies, the ejector principle is again used to produce a vacuum in the connection lines. When the shut-off valves are opened, the air is sucked from the buoyancy bodies. The buoyancy bodies fold up and the covers are closed and locked.

The actuation and locking of the cover flaps is carried out preferably by means of hydraulic cylinders that obtain their energy from the on-board hydraulic system. The actuators control electrohydraulic valves, pressure- and position sensors.

The preparation for the buoyant operation or the retrofitting can be carried out with a computer-controlled program or by manual control.

The inflatable buoyancy bodies are made, for example, of rubberized textile. Larger bodies can be divided into several independent chambers. The buoyancy bodies are preferably fixed to the stowage bodies and the cover flaps with welting profiles. These possess the property of a good memory behavior. Elastic cables are mounted in the interior of the buoyancy bodies to ensure a specific folding-up sequence or configuration, in particular, during emptying. Each body, or each chamber, can be shut off individually with electrically actuated valves.

The advantage of the present inventive solution, among others, is that it does not require any additional construction space. It uses a system that is present in the vehicle. In addition, the filling and emptying can be carried out under ABC protection (i.e., under protection from atomic, bacterial and/or chemical contamination); therefore, the crew does not need to leave the ABC-protected interior area (i.e., an area protected from atomic, bacterial and/or chemical threats), and the system can be operated from inside the vehicle (i.e., from inside the ABC-protected interior area of the vehicle). In addition, the size of the buoyancy bodies can be matched individually to the vehicle (i.e., to match the weight of additional armor).

### BRIEF DESCRIPTION OF THE DRAWINGS

The invention is described in more detail below based on an exemplary embodiment illustrated with drawings. They show:

FIG. 1 illustrates a vehicle of the present invention with closed covers;

FIG. 2 illustrated the vehicle of FIG. 1 ready for buoyant operation with opened covers;

FIG. 3 illustrates the filled buoyancy bodies with opened covers from a perspective from behind the vehicle;

FIG. 4 is a representation of emptying of the buoyancy body and closing of the cover, wherein FIG. 4(a) shows a filled buoyancy body, FIG. 4(b) shows folding-up of the buoyancy body, and FIG. 4(c) shows the cover flap in the closed position; and

FIG. 5 is a flow diagram illustrating the functions representing the filling- and emptying procedure of the buoyancy bodies.

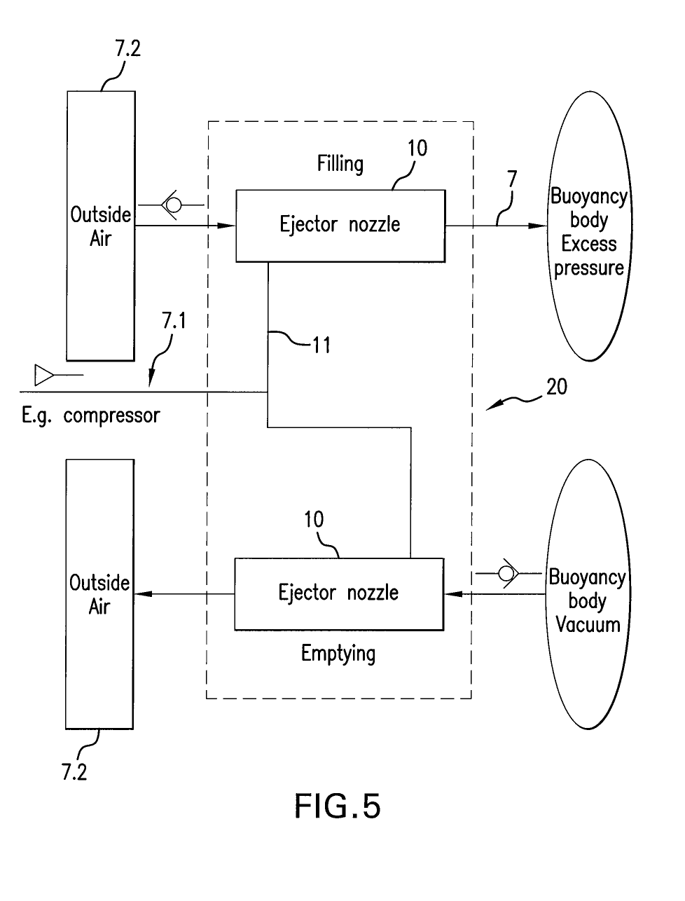

In accordance with FIG. 5, the following lexicon is provided:
Auβenluft: Outside air,
befüllen: Filling,
Ejektordtüse: Ejector nozzle,
entleeren: Emptying,
Auftriebskörper: Buoyancy body,
Überdruck: Excess pressure,
Unterdruck: Vacuum,
z.B. Kompressor: E.g. compressor.

### DETAILED DESCRIPTION OF THE INVENTION

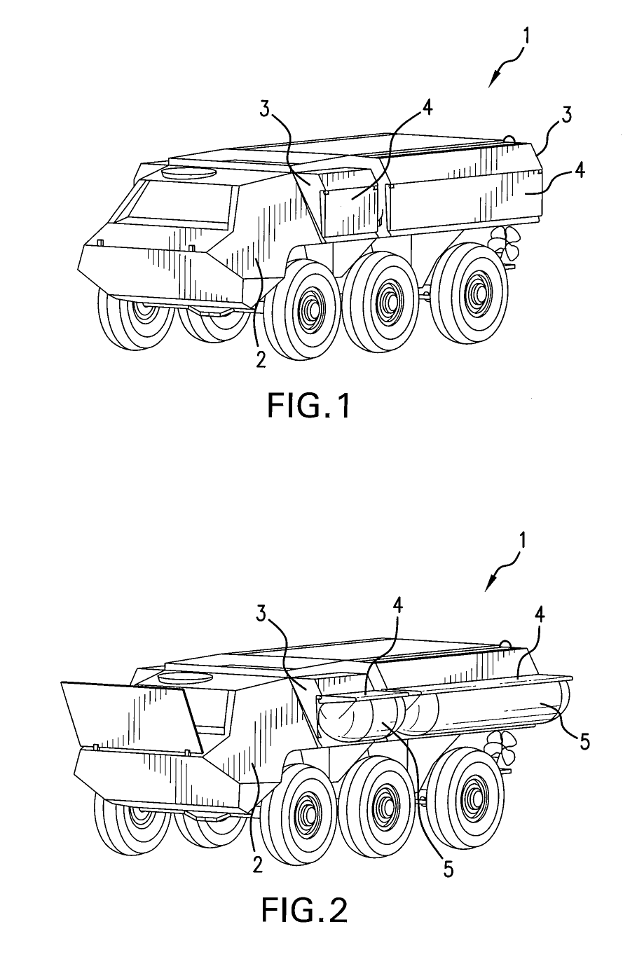

FIG. 1 shows a vehicle 1, in accordance with the present invention, that is provided in this exemplary embodiment with additional armor 2 and has stowage chambers 3. The stowage chambers 3 are closed by covers 4.

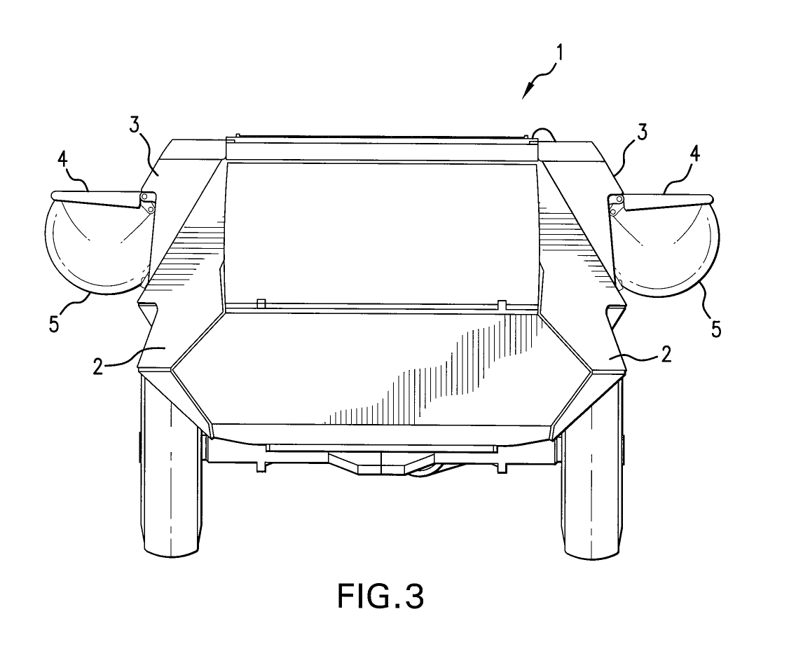

Buoyancy bodies 5, which are shown filled in FIG. 2, are situated in the stowage chambers 3 under the covers 4. The buoyancy bodies 4 are housed in the stowage chambers 3 or at least are disposed bilaterally on the vehicle 1 (FIG. 3).

The buoyancy bodies 5 are preferably made of a rubberized textile, wherein other forms are also possible, and have elastic cables situated inside (not shown in more detail). The buoyancy bodies 5 are fixed to the stowage bodies 3 and the cover flaps 4 preferably with welting profiles (not shown in more detail).

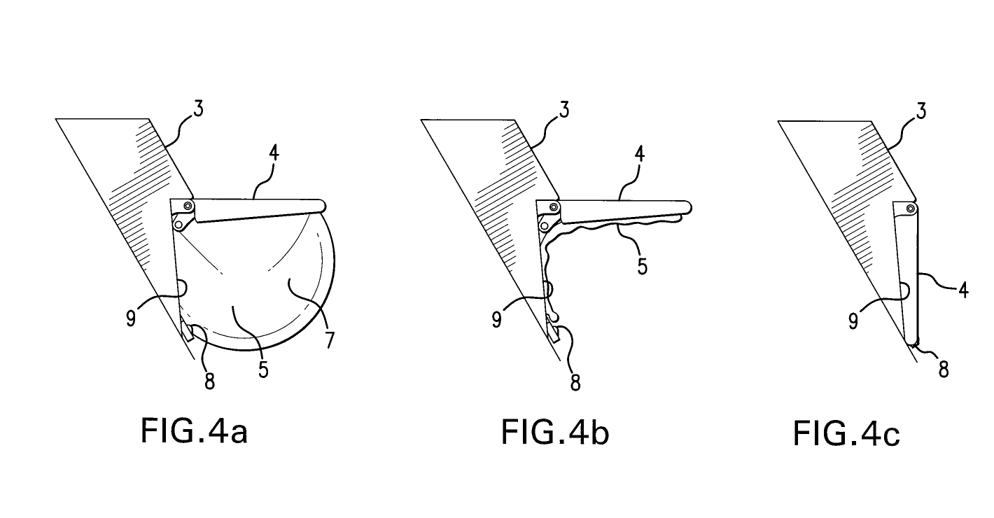

The sequence of emptying the buoyancy bodies 5 is shown in FIG. 4. In FIG. 4(a), the buoyancy body 6 is filled. By removing air 7 situated in the buoyancy body 5 (i.e., buoyancy body emptying is still being performed), the buoyancy body 5 shown here in FIG. 4(a) folds up as shown in FIG. 4(b). With completion of the folding-up procedure of the buoyancy body 5, the buoyancy body lies in the right angle between the cover flap 4 and the tray 9 of the vehicle 1 (See FIG. 4b). The cover flap 4 is then closed by a hydraulic system (See FIG. 4c for the closed state of the cover flap 4) and is locked by means of a lock 8 on the tray 9.

The filling or emptying, respectively, of the buoyancy bodies is explained based on FIG. 5. If a buoyant condition of the vehicle 1 is needed, the release of the covers 4 from the tray 9 is effected, either triggered electronically or manually. To this end, the locks 8 are unlocked and the buoyancy bodies 5 are filled with air 7 provided by an on-board vehicle air system 20, preferably a braking installation of the vehicle, via lines 11.

In order to enable a faster filling, or in order to support the filling, for example because the amount of air 7.1 of the on-board system is not sufficient, it is possible also to use outside air 7.2. Using an ejector nozzle 10 in the line 11 of the vehicle system air 7.1, the outside air 7.2 is now sucked in and thus act on the buoyancy bodies 5 to fill the buoyancy bodies. These buoyancy bodies 5 are thus filled continuously with air 7 (i.e., air 7 that includes vehicle system air 7.1 and outside air 7.2). The filling is controlled via sensors not shown in more detail, and appropriate shutdowns of the valves (not shown in more detail) are undertaken. The vehicle 1 is now buoyant because the buoyancy bodies 5 are filled with air 7, either vehicle air 7.1 supplied from the vehicle air system 20 (e.g., air 7.2 provided by a compressor of the vehicle air system 20) or from outside air 7.2, or from both the vehicle air system 7.1 and the outside air 7.2.

When the buoyant condition is no longer needed, the emptying of the buoyancy bodies 5 now takes place via the same line 11. By producing a reduced pressure, the entire air (i.e., air 7 used to fill the buoyancy bodies) again reaches the surroundings of the outside air 7.2. The ejector nozzle 10, either the same one or a different one, can be used for this purpose. This procedure, according to FIG. 5, can be repeated as often as desired so as to fill or empty the buoyancy bodies 5 as needed.

Of course, vehicle 1 is understood to mean all vehicles that are to be buoyant in water or the like. Thus, vehicle 1 may also be aircraft in which an emergency landing on water is provided as a safety measure. The buoyancy bodies 5 should then be integrated in the outer skin of the vehicle (i.e., aircraft). The controlled release of the locking of the covers can then be carried out, for example, by blasting off a bolt or the like before striking the water. As an example of how to blast off a bolt, one may apply sensor activated pyrotechnic screws as disclosed in U.S. Pat. No. 6,892,621, which is incorporated herein by reference for all that it discloses. Other alternatives are also possible. To support the filling of the buoyancy bodies of an aircraft, the outside air can then be included also as suggested above herein.

1. A vehicle comprising:
an onboard air system: and
at least one buoyancy body that is mounted on the vehicle, wherein filling of the buoyancy body takes place by supplying air of the onboard air system via at least one line connecting the onboard air system to the buoyancy body so the onboard air system is operable to fill the buoyancy body with air.

2. A vehicle according to claim 1, wherein, in addition to onboard air supplied by the onboard air system, outside air is sucked in to fill the, at least one buoyancy body.

3. A vehicle according to claim 1, wherein an ejector nozzle is incorporated in the at least one line.

4. A vehicle according to claim 1, wherein buoyancy bodies are mounted bilaterally on the vehicle.

5. A vehicle according to claim 4, wherein the buoyancy bodies are housed on the vehicle in stowage chambers provided with covers.

6. A vehicle according to claim 5, wherein the buoyancy bodies are fixed to the stowage bodies, and the cover flaps are provided preferably with welting profiles.

7. A vehicle according to claim 4, wherein elastic cables are attached in an interior of each of the buoyancy bodies.

8. A vehicle according to claim 4, wherein the buoyancy bodies are preferably made of a rubberized textile.

9. A vehicle according to claim 8, wherein the buoyancy bodies are each divided into several independent chambers.

10. A vehicle according to claim 5, wherein the buoyancy bodies fold up by means of removal of the air situated in the buoyancy bodies, wherein each buoyancy body lies in a right angle between a respective cover flap and a tray of the vehicle, and the respective cover flap is then operable to close and lock via a hydraulic system of the vehicle.

11. A vehicle according to claim 2, wherein an ejector nozzle is incorporated in the at least one line.

12. A vehicle according to claim 11, wherein buoyancy bodies are mounted bilaterally on the vehicle.

13. A vehicle according to claim 2, wherein buoyancy bodies are mounted bilaterally on the vehicle.

14. A vehicle according to claim 3, wherein buoyancy bodies are mounted bilaterally on the vehicle.

15. A vehicle comprising:
an onboard air system;
a plurality of buoyancy bodies that are mounted on the vehicle, wherein filling of the buoyancy bodies takes place by supplying air via the onboard air system via at least one line connecting the onboard air system to the buoyancy bodies so the onboard air system is operable to fill the buoyancy bodies with air, wherein the buoyancy bodies are housed on the vehicle in stowage chambers provided with covers; and
each cover is provided with one or more bolts that blast off the vehicle before the vehicle hits a body of water so that each cover is released in a controlled manner, thereby permitting the onboard air system to fill the plurality of buoyancy bodies.

16. A vehicle according to claim 16, wherein the vehicle is an aircraft.
